(19) United States
(12) Patent Application Publication
(10) Pub. No.: US 2007/0294347 A1
(43) Pub. Date: Dec. 20, 2007

(54) Message transmission controller capable of confirming viability of message and method of transmitting message by the same

(76) Inventor: Makoto Shinnishi, Kanagawa (JP)

Correspondence Address: DICKSTEIN SHAPIRO LLP, 1825 EYE STREET NW, Washington, DC, 20006-5403, US

(21) Appl. No.: 11/812,498

(22) Filed: Jun. 19, 2007

(30) Foreign Application Priority Data
Jun. 19, 2006 (JP) 2006-168787
Feb. 5, 2007 (JP) 2007-025816

(51) Int. Cl. G06F 15/16

(52) U.S. Cl. 709/204

(57) ABSTRACT

A message transmission controller with location information and time information. Location and time information are used to control delivery to receivers.

This application claims priority from Japanese patent application No. 2006-168787, filed on Jun. 19, 2006, and No. 2007-025816, filed on Feb. 5, 2007, in the Japan Patent Office, the entire contents of which are hereby incorporated by reference herein.

### TECHNICAL FIELD

The present disclosure relates to a method, an apparatus, and a system for controlling a message transmission between one apparatus and another apparatus and, more particularly, to a message transmission controller for controlling a message transmission between one apparatus and another apparatus.

### BACKGROUND

Advancement of technology has been enhancing functionality of portable terminal devices such as cellular phone, PHS (personal handy phone system) device, PDA (personal digital assistant) device, and notebook type PC (personal computer).

For example, cellular phones were introduced as a device for telephone call usage, but cellular phones may also be used as a data communication device. Specifically, cellular phones may be connected to many types of servers via a network (e.g., Internet) to conduct data communication with other devices.

Furthermore, portable terminal devices may have been installed with a positioning device using GPS (global positioning system) satellite. Specifically, portable terminal devices may be installed with a GPS receiver, which receives a positioning signal from a GPS satellite.

Such portable terminal devices may be used in some applications as described below.

For example, a meeting notification system may utilize such portable terminal devices. In such a system, a meeting schedule (e.g., participant names, meeting location, meeting time) may be registered in a server in advance, and when any participants may not appear at a meeting room at a meeting starting-time, such participants may be alarmed with a given signal that a meeting has started by using a in-house PHS telephone, coupled to the meeting notification system.

In another example, an information delivery system using such portable terminal devices may be utilized at a zoo. In such a system, a user of portable terminal device (e.g., cellular phone) may receive specific animal information with a portable communication device when the user comes to a location (e.g., cage) of a specific animal.

Such portable communication devices may be used to transmit a message from a message sending person to a message receiving person by electronic mail function or telephone call function, for example.

A message sending person may transmit a message to a message receiving person requesting the message receiving person to take an action for the message sending person once received such message. Such a message is referred to as a “action-requesting message.”

However, the message receiving person may not be located at a right place at the right time for conducting such action-requesting message in some cases. In such cases, the message receiving person may not or cannot conduct an action requested by the action-requesting message.

In addition, a message sending person may need to select a message receiving person who can respond to such action-requesting message when transmitting such action-requesting message.

For example, a message sending person may ask or request someone to buy bottled water for the message sending person with such system. The message sending person may send such action-requesting message (e.g., “please buy me bottled water”) to another known person by portable communication device with e-mail or telephone call function. However, if the message receiving person is not be located at a right place at a right time to buy a bottle of water, such action-requesting message may not be accomplished.

Furthermore, before sending an action-requesting message, the message sending person may need to send e-mail or make a telephone call to check a present location of message receiving person whether the message receiving person is located at a right place, which can respond to the action-requesting message.

Such processes may be an inconvenient step for message sending person.

### SUMMARY

The present disclosure relates to a message transmission controller for use in a controlling of message transmission between a first terminal apparatus and a second terminal apparatus. The message transmission controller includes a storing device, a receiving unit, and a controlling unit. The storing device stores message-related information including addressee information for identifying the second terminal apparatus, location designating information for designating a given location for the second terminal apparatus, and an action-requesting message to be transmitted to the second terminal apparatus. The action-requesting message includes a message to be transmitted to the second terminal apparatus from the first terminal apparatus. The receiving unit receives location information indicating a location of the second terminal apparatus. The controlling unit, controlling a message transmission between the first and second terminal apparatus, judges whether to transmit the action-requesting message to the second terminal apparatus by comparing the location designating information and the location information received from the second terminal apparatus, and the controlling unit transmits the action-requesting message to the second terminal apparatus when the controlling unit judges to transmit the action-requesting message to the second terminal apparatus.

The present disclosure also relates to a method of controlling a message transmission between a first terminal apparatus and a second terminal apparatus. The method includes the steps of storing, receiving, judging, and transmitting. The storing step stores message-related information including addressee information for identifying the second terminal apparatus, location designating information for designating a given location for the second terminal apparatus, and an action-requesting message to be transmitted to the second terminal apparatus. The action-requesting message includes a message to be transmitted to the second terminal apparatus from the first terminal apparatus. The receiving step receives location information indicating a location of the second terminal apparatus. The determining step judges whether transmitting the action-requesting message to the second terminal apparatus by comparing the location designating information and the location information received from the second terminal apparatus. The transmitting step transmits the action-requesting message to the second terminal apparatus based on the location designating information and the location information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic message transmission system including a message transmission controller used for controlling a message transmission from one terminal apparatus to another terminal apparatus according to an example embodiment;

FIG. 2 is a block diagram of a terminal apparatus used for a message transmission system of FIG. 1;

FIG. 3 is a block diagram of a message transmission controller used for a message transmission system of FIG. 1;

FIG. 4 is a table for message-related information stored in a message transmission controller of FIG. 3;

FIG. 5 is a flow chart for explaining a process of transmitting a message between one terminal apparatus and another terminal apparatus;

FIGS. 6A and 6B are an example user interface for registering message-related information;

FIG. 7 is an example user interface for executing a response for an action-requesting message;

FIG. 8 is an example user interface for notifying a transmission result of action-requesting message;

FIG. 9 is a table for message-related information stored in a message transmission controller of FIG. 3;

FIG. 10 is another flow chart for explaining a process of transmitting a message between one terminal apparatus and another terminal apparatus;

FIG. 11 is another example user interface for registering message-related information;

FIG. 12 is another example user interface for notifying a transmission result of action-requesting message; and

FIG. 13 is another example user interface for notifying a transmission result of action-requesting message.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present.

Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

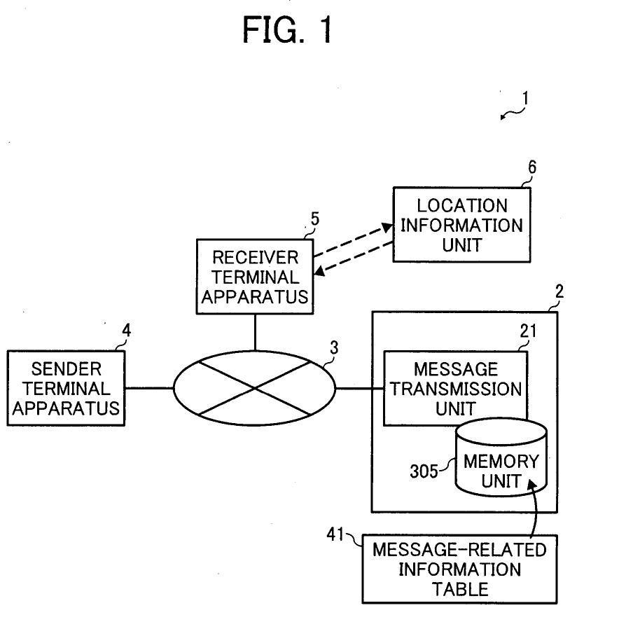

Referring now to the drawings, wherein like reference numerals designate identical or corresponding parts throughout the several views, a message transmission system according to an example embodiment is described with particular reference to FIG. 1.

FIG. 1 schematically shows a message transmission system 1 according to an example embodiment.

As shown in FIG. 1, the message transmission system 1 may include a message transmission controller 2, a sender terminal apparatus 4, a receiver terminal apparatus 5, and a network 3, for example. The message transmission controller 2, sender terminal apparatus 4, and receiver terminal apparatus 5 may be connected or coupled each other via the network 3 so that information or data can be communicated between such apparatuses.

In such message transmission system 1, one person may use the sender terminal apparatus 4 to send a message such as action-requesting message to another person having the receiver terminal apparatus 5.

The message transmission system 1 may further include a location information unit 6. The location information unit 6 may communicate with the receiver terminal apparatus 5 to send location information to the receiver terminal apparatus 5. The location information unit 6 may include a RFID (radio frequency identification) unit and a GPS (global positioning system), for example, but not be limited these units. Although not shown, the location information unit 6 may be configured to communicate with the sender terminal apparatus 4, as required.

The sender terminal apparatus 4 and receiver terminal apparatus 5 may include a portable apparatus such as cellular phone, PHS telephone, PDA device, portable notebook type PC, for example, but are not limited to these devices.

The sender terminal apparatus 4 may also include a non-portable apparatus such as desktop PC (personal computer) and land-line phone, for example.

The network 3 may include an interlinked communication line system such as telephone line network (including cellular phone line network), LAN (local area network), WAN (wide area network), the Internet, and Intranet, which may be connected or coupled each other, as required.

The sender terminal apparatus 4 may be owned or used by a message sending person.

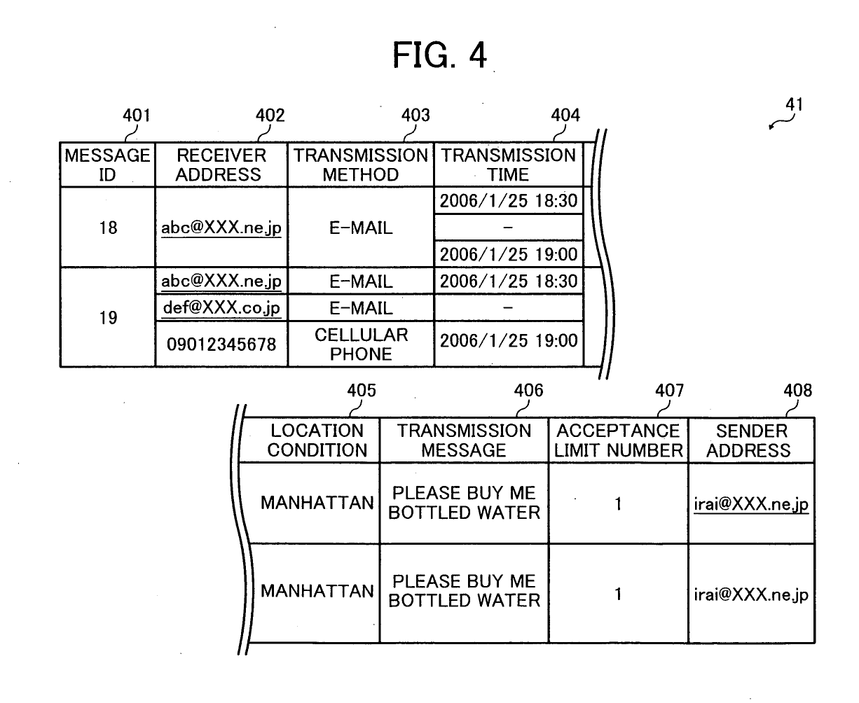

The message sending person may input information to be requested to a message receiving person from the sender terminal apparatus 4. Such information may include message data (e.g., action-requesting message) and associated other data. Hereinafter, Such information as a whole may be termed as “message-related information.” An example of “message-related information” will be explained later with FIG. 4.

Such message-related information may be transmitted from the sender terminal apparatus 4 to the message transmission controller 2.

Furthermore, such message-related information may include personal memorandum, which may be input by a message sending person as recording note to prevent the message sending person from forgetting an important action to be conducted later.

Hereinafter, a message receiving person may include a person who receives a message such as action-requesting message. Such message receiving person may also include a message sending person himself or herself if one person may function as both of message sending person and message receiving person in case such as the above-mentioned personal memorandum case.

The receiver terminal apparatus 5, owned or used by a message receiving person, may receive a message such as action-requesting message from the message transmission controller 2.

The message transmission controller 2 may include a computer server, which may control a message transmission process between the sender terminal apparatus 4 and receiver terminal apparatus 5.

As shown in FIG. 1, the message transmission controller 2 may include a message transmission unit 21 and a memory unit 305, for example.

The message transmission unit 21 may transmit an action-requesting message to the receiver terminal apparatus 5 via the network 3.

The memory unit 305 may store message-related information as message-related information table 41 (refer to FIG. 4). The memory unit 305 may be included inside of the message transmission controller 2, or may be separate from the message transmission controller 2 and connected or coupled thereto, for example.

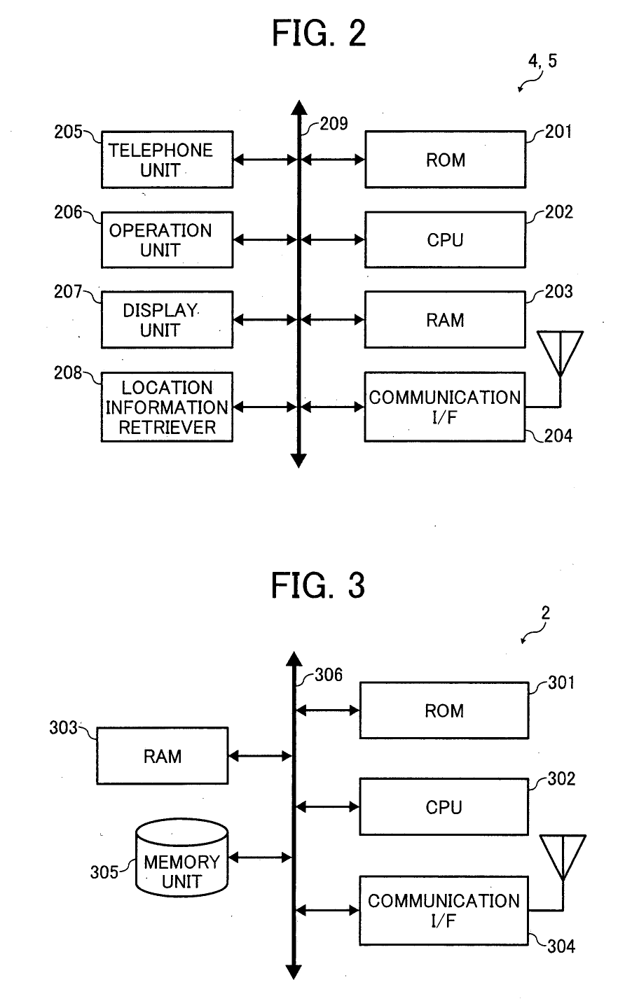

FIG. 2 shows a block diagram of the sender terminal apparatus 4 or receiver terminal apparatus 5. In general, the sender terminal apparatus 4 and receiver terminal apparatus 5 may have a substantially similar internal configuration.

As shown in FIG. 2, each terminal apparatus may include a ROM (read only memory) 201, a CPU (central processing unit) 202, a RAM (random access memory) 203, a communication interface (I/F) 204, a telephone unit 205, an operation unit 206, a display unit 207, a location information retriever 208, and a bus 209, which may connect or couple the above-mentioned units in the terminal apparatus.

The ROM 201 may store a plurality of programs: a program for processing telephone call; a program for processing communication between terminal apparatuses and message transmission controller 2; a program for processing electronic mail between an e-mail server (not shown) and other units or apparatuses, and other programs for processing information.

Furthermore, the ROM 201 may store telephone numbers, address data, or electronic mail received by each terminal apparatus, for example.

The CPU 202 may allocate a working memory area in the RAM 203 to execute the above-mentioned programs.

The RAM 203 may temporarily store information or data to be processed by the CPU 202.

The communication interface 204 may be used to couple a terminal apparatus to the network 3. For example, a cellular phone may be coupled to the network 3 via a base transceiver station (not shown) to send or receive information.

The telephone unit 205 may include a microphone and a speaker, for example. When making a telephone call between terminal apparatuses, a user's (or operator's) voice, picked up by the microphone, may be converted to an electrical signal, and the speaker may output a received electrical signal as audio sound.

The operation unit 206 may include a keypad having numerical keys and character keys, for example. A user (or operator) may press or touch keys to input information such as telephone number, address data, character strings (e.g., sentence), process code, which may be transmitted to the CPU 202. Furthermore, the operation unit 206 may include a mouse unit or track ball unit to input information, for example.

The location information retriever 208 may be configured with the location information unit 6 such as GPS system. Although not shown, in case of GPS system, such GPS system may be configured with a GPS satellite and GPS device (e.g., location information retriever 208).

The location information unit 6 such as GPS satellite may compute location information (e.g., latitude/longitude) of terminal apparatus having the location information retriever 208, and transmit such location information to the location information retriever 208. In other words, the location information retriever 208 may receive location information of the terminal apparatus from the location information unit 6 (e.g., GPS satellite).

The display unit 207 may include a liquid crystal display disposed on a surface of the terminal apparatus, for example. The display unit 207 may display information under a control of CPU 202.

FIG. 3 is a block diagram for the message transmission controller 2. As shown in FIG. 3, the message transmission controller 2 may include a ROM 301, a CPU 302, a RAM 303, a communication interface (I/F) 304, a memory unit 305 (e.g., hard disk), an operation unit (not shown), and a display unit (not shown), which may be connected or coupled each other via the bus 306.

The ROM 301 may store a plurality of programs: a program for processing communication between terminal apparatus and message transmission controller 2; a program for processing electronic mail between an e-mail server (not shown) and other units or apparatuses, and other programs for processing information.

The CPU 302 may allocate a working memory area in the RAM 303 to execute the above-mentioned programs.

The RAM 303 may store address data and telephone number, for example.

The communication interface (I/F) 304 may couple the message transmission controller 2 to the network 3 for communicating information or data with other devices.

The operation unit (not shown) may include a keypad having numerical key and character keys, for example. A user (or operator) may press or touch keys to input information or data to the message transmission controller 2.

The display unit (not shown) may include a liquid crystal display disposed on a surface of the message transmission controller 2, for example. The display unit may display information under a control of CPU 302.

The memory unit 305 may include a recording medium such as hard disk, which may store message-related information table 41 shown in FIG. 4 as database.

As shown in FIG. 4, the message-related information table 41 may include itemized category information such as message ID (identification) 401, receiver address 402, transmission method 403, transmission time 404, location condition 405, transmission message 406, acceptance limit number 407, and sender address 408, for example. Each of itemized category information may have specific data as shown in FIG. 4.

Hereinafter, each of itemized category information in the message-related information table 41 is explained with reference to FIG. 4.

The message ID 401 may include an identification code (e.g., number, character) assigned to each of message-related information stored in the message-related information table 41. Such message ID may be used to identify each message-related information.

The receiver address 402 may include addressee information for identifying the receiver terminal apparatus 5, which receives an action-requesting message. Such addressee information may include e-mail address, and telephone number of the receiver terminal apparatus 5, for example.

The transmission method 403 may include transmission route information, which may designate a data transmission route to the receiver terminal apparatus 5. As shown in FIG. 4, the transmission route information may include an e-mail route, a telephone line route, or a web-based route (not shown), for example. The transmission method 403 may be determined based on the addressee information specified in the receiver address 402 or may be determined based on message-related information, input by a message sending person from the sender terminal apparatus 4.

The transmission time 404 may include time-line information, for example. An action-requesting message may be transmitted to the receiver terminal apparatus 5 at a time designated by the time-line information. The time-line information may include a specific time or a time period.

The location condition 405 may include location designating information for the receiver terminal apparatus 5. The receiver terminal apparatus 5 may be supposed to receive an action-requesting message at a location designated by the location designating information. Such location may include any location or place such as meeting room in a building or a given area (e.g., Washington D.C., Manhattan, Eiffel tower), for example.

The transmission message 406 may include an action-requesting message, input by a message sending person and to be requested to a message receiving person having the receiver terminal apparatus 5. The action-requesting message may include at least one data format such as a character string (e.g., sentence), audio data, image data, moving image data, or the like.

The acceptance limit number 407 may include information, which may limit a number of transmitting times of an action-requesting message to the receiver terminal apparatus 5. A message sending person may set a limit for transmitting an action-requesting message to the receiver terminal apparatus 5.

When the receiver terminal apparatus 5 receives and accepts to accomplish an action-requesting message, a counter (not shown) may recognize such acceptance process as one count of acceptance.

The message transmission controller 2 may transmit an action-requesting message to the receiver terminal apparatus 5 until the counter (not shown) counts a given acceptance limit number, which may limit the number of times of an action-requesting message is transmitted to the receiver terminal apparatus 5.

The sender address 408 may include requester information for identifying a message sending person using the sender terminal apparatus 4. As similar to the above-mentioned addressee information of receiver address 402, the requester information may include e-mail address and telephone number, for example, to identify the sender terminal apparatus 4.

As shown in FIG. 4, a group of itemized category information may constitute one message-related information as shown in the message-related information table 41.

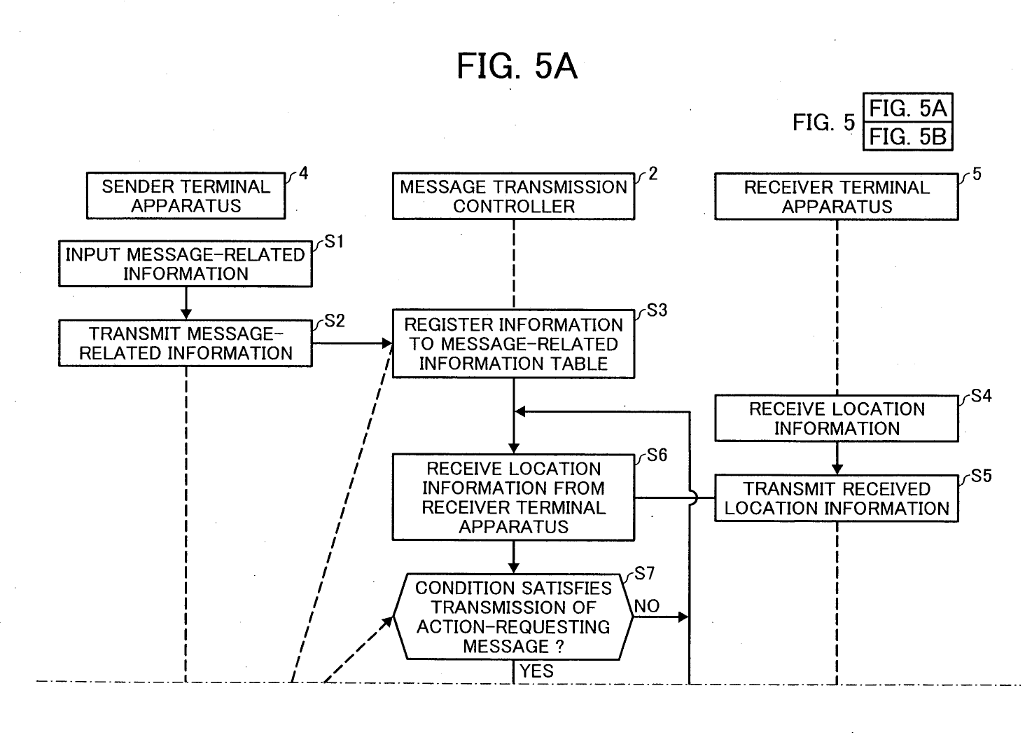

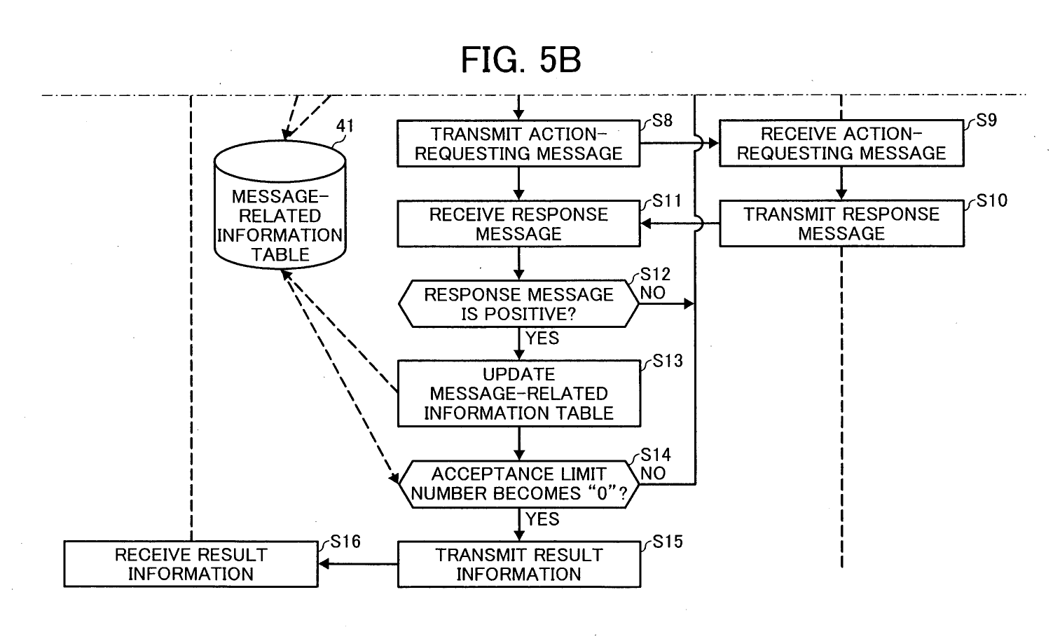

Hereinafter, an example embodiment for controlling a message transmission between terminal apparatuses is explained with reference to FIG. 5 to 8.

FIG. 5 shows a method of transmitting a message from a message sending person to a message receiving person with the message transmission system 1. The message transmission system 1 may be operated as below.

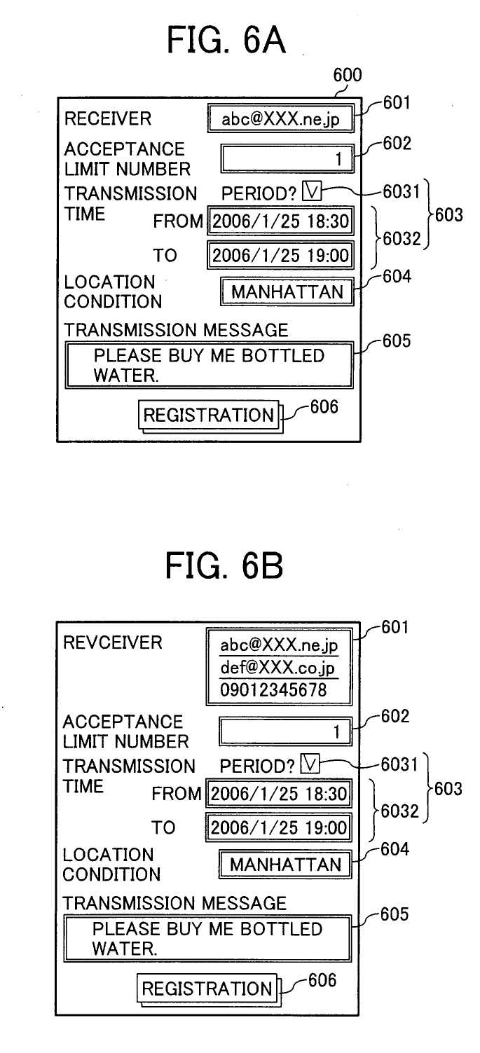

The sender terminal apparatus 4 may display an input screen 600 (refer to FIG. 6A) on the display unit 207. A message sending person may input message-related information on the input screen 600.

As shown in FIG. 6A, the input screen 600 may have boxes to be input with given information.

A receiver box 601 may be input with addressee information identifying the receiver terminal apparatus 5, which may receive an action-requesting message.

An acceptance limit number box 602 may be input with an acceptance limit number, which may be used to limit a number of transmission times of action-requesting message to the receiver terminal apparatus 5. In other words, the acceptance limit number may be used as transmission limiting information.

A transmission time box 603 may include a “Period?” box 6031 and a time designating box 6032.

The “Period?” box 6031 may be used to designate whether time-line information is a specific time or a time period. In this disclosure, “specific time” refers to a time having no substantial time period such as “at 9:00 AM exactly,” for example, and “time period” refers to a given period such as “from 9:00 AM to 10:00 AM,” for example.

If “Period?” box 6031 is marked with a check mark, an action-requesting message may be transmitted to the receiver terminal apparatus 5, input in the receiver box 601 as addressee information, with a given time period to be set as below.

If “Period?” box 6031 is not marked with a check mark, an action-requesting message may be transmitted to the receiver terminal apparatus 5 at a specific time.

The time designating box 6032 may be input with time information.

With such “Period?” box 6031 and time designating box 6032, time-line information may be input from the sender terminal apparatus 4.

In an example screen shown in FIG. 6A, the “Period?” box 6031 may have a check mark. If the check mark is input to the “Period?” box 6031, the time-line information may set as a given time period.

If a check mark is input in the “Period?” box 6031, a first and second column may be displayed on the input screen 600 to designate a given time period with two different times. For example, the first column may be input with “2006/1/25 18:30” and the second column may be input with “2006/1/25 19:00” to designate the time-line information from “2006/1/25 18:30” to “2006/1/25 19:00.”

If the “Period?” box 6031 may not be marked with a check mark, the time-line information may be determined by a given pinpointing time. In such case, the time designating box 6032 may appear as one column or two columns, in which one column may be input with a given pinpointing time such as “2006/2/25 20:00”.

The location condition box 604 may be input with location designating information indicating a location condition of the receiver terminal apparatus 5, at which the receiver terminal apparatus 5 may be supposed to receive an action-requesting message from the message transmission controller 2.

In an example screen shown in FIG. 6A, “Manhattan” is the location condition.

If one person having the receiver terminal apparatus 5, set with a location condition of “Manhattan,” is in or around Manhattan, an action-requesting message may be transmitted to such receiver terminal apparatus 5.

The transmission message box 605 may include a message, wherein the message may include an action-requesting message. The action-requesting message may include information to be transmitted to a person having receiver terminal apparatus 5 requesting they do something if such receiver terminal apparatus 5 has addressee information input by the message sending person.

A message may be included in the action-requesting message and may be input as a character string (e.g., sentence), audio data, image data, or the like, for example. In an example screen shown in FIG. 6A, an included message is “please buy me bottled water.”

The message sending person may complete an information inputting process on the input screen 600 by pressing a “registration” button 606.

When the message sending person presses the “registration” button 606, the sender terminal apparatus 4 may configure message-related information, which may include information inputted from the input screen 600 and other information (e.g., identification information of the sender terminal apparatus 4) at step S1 shown in FIG. 5.

At step S2 in FIG. 5, the sender terminal apparatus 4 may transmit the message-related information to the message transmission controller 2.

At step S3, the message transmission controller 2 may receive the message-related information from the sender terminal apparatus 4.

The message transmission controller 2 may store and register such received message-related information in message-related information table 41, in which data of the received message-related information may be corresponded to each of itemized category information in the message-related information table 41.

For example, if the message transmission controller 2 may receive the message-related information input via the input screen 600 shown in FIG. 6A, each data in the message-related information may be corresponded to each of itemized category information in the message-related information table 41 (FIG. 4) as below.

The receiver address 402 may include addressee information, such as an e-mail address, e.g. “abc@XXX.ne.jp,” for identifying the receiver terminal apparatus 5.

The transmission time 404 may include time-line information of from “2006/1/25 18:30” to “2006/1/25 19:00.”

The location condition 405 may include location designating information of “Manhattan.”

The transmission message 406 may include an action-requesting message of “please buy me bottled water.”

The acceptance limit number 407 may include acceptance limit number of “1.”

The sender address 408 may include information, such as an email address, e.g. “irai@XXX.ne.jp,” for identifying the sender terminal apparatus 4.

As shown in FIG. 4, one message-related information may be assigned with unique message ID (e.g., 18, 19) to register one message-related information in the message-related information table 41.

At step S4 shown in FIG. 5, the receiver terminal apparatus 5 may receive location information of the receiver terminal apparatus 5 at a given time, and transmit the received location information and identification information of the receiver terminal apparatus 5 to the message transmission controller 2 at step S5.

Such identification information of the receiver terminal apparatus 5 may be addressee information of the receiver terminal apparatus 5, which may be registered in the message-related information table 41 as e-mail address, and telephone number, or identification information of the location information retriever 208 of the receiver terminal apparatus 5, for example.

In the above-mentioned case, the receiver terminal apparatus 5 may receive location information from the location information unit 6 (e.g., GPS system) and transmit such received location information to the message transmission controller 2 at a given time interval without any specific instruction from the message transmission controller 2.

In another case, the message transmission controller 2 may generate and transmit a signal instructing the receiver terminal apparatus 5, registered in the message-related information table 41 with addressee information, to receive location information from the location information unit 6 (e.g., GPS system) and to transmit such received location information to the message transmission controller 2.

At step S6, the message transmission controller 2 may receive the location information of the receiver terminal apparatus 5.

At step S7, the CPU 302 may compare the location information received from the receiver terminal apparatus 5 and the location designating information registered in the message-related information table 41, and may determine whether the location information received from the receiver terminal apparatus 5 matches to the location designating information.

Specifically, the CPU 302 may determine whether the location designating information registered in the message-related information table 41 includes the location information received from the receiver terminal apparatus 5.

The location designating information may include location information designated by a message sending person. Such message sending person may designate any given location depending on a need of the message sending person.

For example, a message sending person may select and designate a greater area (e.g., Manhattan in New York City) or a smaller area (e.g., Times Square in New York City).

Such location information having a different level of area information may be stored in the memory unit 305 in a database, for example.

The message transmission controller 2 may further include a clock-time counter (not shown) to obtain clock-time information (e.g., year, month, day, clock time) when the message transmission controller 2 receives the location information from the receiver terminal apparatus 5, for example.

As above-mentioned, at step S7, the CPU 302 may compare the location information received from the receiver terminal apparatus 5 and location designating information registered in the message-related information table 41.

In addition to such location information comparison, the CPU 302 may compare the obtained clock-time information and time-line information registered in the message-related information table 41 to determine whether the clock-time information is included in the time-line information at step S7.

In an example embodiment, the CPU 302 may recognize clock-time information: when the message transmission controller 2 receives the location information from the receiver terminal apparatus 5; when the receiver terminal apparatus 5 receives location information from the location information unit 6 (e.g., GPS system); or when the receiver terminal apparatus 5 transmits location information to the message transmission controller 2.

In such cases, the receiver terminal apparatus 5 may transmit such clock-time information to the message transmission controller 2 with the location information of the receiver terminal apparatus 5 as one set of information, for example.

The CPU 302 may compare such clock-time information and time-line information in the message-related information table 41 to judge whether the clock-time information is included in the time-line information.

If the CPU 302 may judge that such received location information of the receiver terminal apparatus 5 satisfies the location designating information (YES at step S7), the message transmission controller 2 may transmit the action-requesting message to the receiver terminal apparatus 5 at step S8.

Similarly, if the CPU 302 may judge that such received location information and clock-time information of the receiver terminal apparatus 5 satisfy the location designating information and time-line information (YES at step S7), the message transmission controller 2 may transmit the action-requesting message to the receiver terminal apparatus 5 at step S8.

If the CPU 302 may judge that such received location information of the receiver terminal apparatus 5 does not satisfy the location designating information of message-related information registered in the message-related information table 41 (No at step S7), the process goes back to step S6, and a standby condition may be set, in which the message transmission controller 2 may wait for receiving location information from the receiver terminal apparatus 5.

At step S9, the receiver terminal apparatus 5 may receive the action-requesting message from the message transmission controller 2.

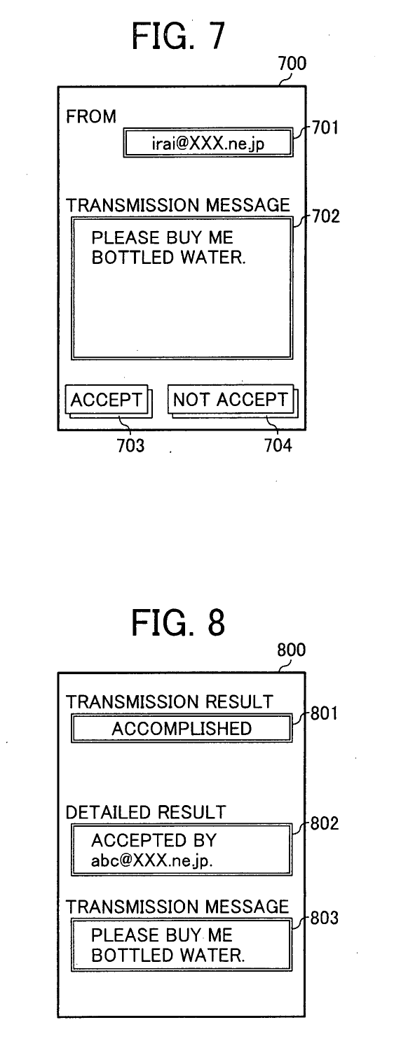

When the receiver terminal apparatus 5 receives the action-requesting message, the receiver terminal apparatus 5 may display a notice screen 700 shown in FIG. 7, which may display an action-requesting message and request a message receiving person to make a response message for the action-requesting message. Such message receiving person, who see the notice screen 700, may input a response message=to be transmitted to a message sending person.

As shown in FIG. 7, the notice screen 700 may include a FROM box 701 and a transmission message box 702, for example.

The FROM box 701 may display information for identifying a message sending person having or using the sender terminal apparatus 4.

For example, such information may include an e-mail address of the sender terminal apparatus 4, a name of person having or using the sender terminal apparatus 4, or the like.

In an example screen shown in FIG. 7, the FROM box 701 may display an e-mail address such as “irai@XXX.ne.jp” of the sender terminal apparatus 4, which is registered as sender address 408 in the message-related information table 41.

The transmission message box 702 may display the action-requesting message.

The notice screen 700 may also include a “accept” button 703 and a “not accept” button 704 as shown in FIG. 7.

The message receiving person may select the “accept” button 703 when to accept conducting an action requested by the action-requesting message, or select the “not accept” button 704 when not to accept conducting an action requested by the action-requesting message, as a response message for the action-requesting message shown in the transmission message box 702.

When the message receiving person may select the “accept” button 703 or “not accept” button 704 as a response message for the action-requesting message, the receiver terminal apparatus 5 may transmit such response message to the message transmission controller 2 at step S10.

At step S11, the message transmission controller 2 may receive the response message from the receiver terminal apparatus 5.

At step S12, the CPU 302 may judge whether the response message includes a positive response or negative response for the action-requesting message.

If the action-requesting message is “please buy me bottled water,” a “positive response” may mean that the message receiving person may accept to “buy bottled water,” and a “negative response” may mean that the message receiving person does not accept to “buy bottled water” or is unable to “buy bottled water.”

In an example embodiment, a “positive response” may be corresponded to the “accept” button and a “negative response” may be corresponded to the “not accept” button, which may be pressed by a message receiving person (or responding person).

If the CPU 302 of message transmission controller 2 may judge that the response message includes a positive response for the action-requesting message (Yes at step S12), the CPU 302 may reduce a number of acceptance limit number in the acceptance limit number 407 of the message-related information table 41 for one point, and updates the acceptance limit number in the message-related information table 41 at step S13.

As above explained, the acceptance limit number 407 may limit a number of transmitting times of an action-requesting message to the receiver terminal apparatus 5.

If the CPU 302 may judge that the response message includes a negative response for the action-requesting message (NO at step S12), the process goes back to step S6, and a standby condition may be set, in which the message transmission controller 2 may wait for receiving location information from the receiver terminal apparatus 5.

At step S14, the CPU 302 may refer to the updated message-related information table 41 to judge whether the acceptance limit number in the acceptance limit number 407 becomes “0 (zero).”

If the CPU 302 judges that the acceptance limit number in the acceptance limit number 407 becomes “0 (zero)” (Yes at step S14), the CPU 302 may transmit a result information that the message-related information is accomplished in a way that the message sending person has wished to the sender terminal apparatus 4 at step S15.

When the sender terminal apparatus 4 may receive the result information from the message transmission controller 2 at step S16, the process has completed.

FIG. 8 is an example result-showing screen 800 of the sender terminal apparatus 4. The result-showing screen 800 may show result information received by the sender terminal apparatus 4.

The result-showing screen 800 may include a transmission result box 801, a detailed result box 802, and a transmission message box 803, for example.

The transmission result box 801 may display a result whether the action-requesting message requested by the message sending person is accomplished or not.

In an example screen shown in FIG. 8, the transmission result box 801 may display “accomplished,” which may indicate that the action-requesting message requested by the message sending person is accomplished.

The detailed result box 802 may display a result of which person has “accepted” or “not accepted” for the action-requesting message requested by the message sending person.

In an example screen shown in FIG. 8, the detailed result box 802 may display that the action-requesting message (i.e., transmission message 406) of “please buy me bottled water” is accepted by a person having e-mail address of “abc@XXX.ne.jp.”

The transmission message box 803 may display the action-requesting message.

With such result information, the message sending person may be notified with information including action-requesting message requested by the message sending person, a result of action-requesting message, and a result information of who will accomplish the action-requesting message.

As such, the message sending person can confirm a result of action-requesting message by viewing result information on the result-showing screen 800.

If the CPU 302 judges that the acceptance limit number in the acceptance limit number 407 does not become “0 (zero)” at step S14, the CPU 302 may judge that message-related information requested by message sending person may not be satisfied, and the process goes back to step S6, and a standby condition may be set, in which the message transmission controller 2 may wait for receiving location information from the receiver terminal apparatus 5.

Because the message sending person may set a given acceptance limit number in the acceptance limit number 407 depending on a need of message sending person, such acceptance limit number in the acceptance limit number 407 may need to become “0 (zero)” to satisfy a request made by the message sending person when conducting a message transmission.

In the above explanation, a message receiving person may select the “accept” button 703 or the “not accept” button 704 as a response message for the action-requesting message at step S10.

In addition to such method, although not shown, a message receiving person may input a character string (e.g., sentence), image data or the like as response message for the action-requesting message. In such a case, the CPU 302 may judge the response message at step S12 as below.

For example, the message transmission controller 2 may transmit a response message (e.g., character string, image data), received from the receiver terminal apparatus 5, to the sender terminal apparatus 4.

Then, a message sending person may judge whether the response message (e.g., character string, image data) includes a positive response or negative response for the action-requesting message, and input a judgment result to the sender terminal apparatus 4. The CPU 202 of the sender terminal apparatus 4 may transmit such judgement result information to the message transmission controller 2.

The CPU 302 of message transmission controller 2 may receive the judgement result information as response message, and may judge whether the response message includes a positive response or negative response for the action-requesting message at step S12.

As above-explained, in an example embodiment, a message sending person may designate given location information, or given location and time information when the message sending person may input and register message-related information to the sender terminal apparatus 4. A message receiving person may be supposed to accomplish an action requested by an action-requesting message at such given location or given location and time.

The message transmission controller 2 may transmit the action-requesting message to a message receiving person having the receiver terminal apparatus 5, who may be in the designated given location, or designated given location and time.

Accordingly, the message transmission controller 2 can transmit the action-requesting message to a message receiving person who may be in a right place, or a right place/time to accomplish an action requested by action-requesting message.

Accordingly, a message sending person can transmit an action-requesting message to a message receiving person effectively at a desired timing with the message transmission system 1.

Furthermore, in an example embodiment, when a message sending person may input and register message-related information to the sender terminal apparatus 4, the message sending person may designate transmission limiting information, which may limit a number of times of sending an action-requesting message to the receiver terminal apparatus 5.

When the CPU 302 of message transmission controller 2 receives a response message from the receiver terminal apparatus 5, the CPU 302 may determine whether to transmit an action-requesting message to the receiver terminal apparatus 5 furthermore by considering a content of received response message.

For example, assume a case that a message sending person may input message-related information to the sender terminal apparatus 4, which may designate a plurality of receiver terminal apparatuses 5 (as transmission destinations) with a request of “please buy me bottled water” and set acceptance limit number (or transmission limiting information) to “1” as shown in an example input screen of FIG. 6B.

In such a case, the message sending person may set the acceptance limit number to “1” because he or she may need one bottled water.

If the message sending person may not set the acceptance limit number or may set a greater number for acceptance limit number such as “5,” an action-requesting message may be accomplished for a number of times more than a message sending person may whish. For example, if a request of “please buy me bottled water” may be accomplished for greater number of times, the message sending person may feel inconvenience of receiving a greater number of bottled water.

The CPU 302 of message transmission controller 2 may transmit an action-requesting message to the plurality of receiver terminal apparatuses 5, which may satisfy location designating information or time-line information of addressee information, one by one.

If the CPU 302 may receive a positive response from one receiver terminal apparatus 5, and such positive response may satisfy an acceptance limit number set in the massage-related information table 40, the message the CPU 302 may stop another message transmission to other receiver terminal apparatuses 5.

With such process, the message transmission controller 2 may not transmit the action-requesting message to the plurality of receiver terminal apparatuses 5 unnecessarily while satisfying a need of a message sending person.

If a plurality of receiver terminal apparatuses 5 may be used, the message transmission controller 2 may receive location information and clock-time information from such plurality of receiver terminal apparatuses 5 at step S6, and the CPU 302 may compare the location information and clock-time information with the registered location designating information and time-line information to determine which receiver terminal apparatuses 5 may satisfy a condition for transmitting an action-requesting message at step S7 in FIG. 5.

If two or more receiver terminal apparatuses 5 may satisfy a condition for transmitting an action-requesting message, the CPU 302 may transmit the action-requesting message to one receiver terminal apparatus 5, which satisfies a condition for transmitting an action-requesting message at first, and then transmit the action-requesting message to another receiver terminal apparatus 5 at step S8.

In other words, the CPU 302 may transmit the action-requesting message to two or more receiver terminal apparatuses 5 in sequential manner by comparing a timing of satisfying a condition for transmitting an action-requesting message among the two or more receiver terminal apparatuses 5.

In such process, the action-requesting message may not be transmitted to two or more receiver terminal apparatuses 5 at the same time.

Specifically, after the message transmission controller 2 receives a response message from one receiver terminal apparatus 5, the message transmission controller 2 may transmit the action-requesting message to another receiver terminal apparatus 5, which may satisfy a condition for message transmission but may not be transmitted with the action-requesting message.

In such a case, the message-related information table 41 shown in FIG. 4 may include a ready-condition flag (not shown).

The ready-condition flag may be set to “ON” for a receiver terminal apparatus 5, which satisfies a location information or time information for receiving an action-requesting message, but has not been transmitted with an action-requesting message.

When one receiver terminal apparatus 5 may have a ready-condition flag set to “ON,” such receiver terminal apparatus 5 can be transmitted with an action-requesting message from the message transmission controller 2.

The CPU 302 of message transmission controller 2 may check a status (e.g., ON or OFF) of ready-condition flag in the message-related information table 41.

If the CPU 302 confirms that acceptance limit number is not “0” (No at step S14) and at least one receiver terminal apparatus 5 has a ready-condition flag of ON, the CPU 302 may transmit an action-requesting message to such receiver terminal apparatus 5.

With such process, even if a plurality of receiver terminal apparatuses 5 may satisfy condition for message transmission, an action-requesting message may not be transmitted the plurality of receiver terminal apparatuses 5 at the same time but may be transmitted in a sequential manner.

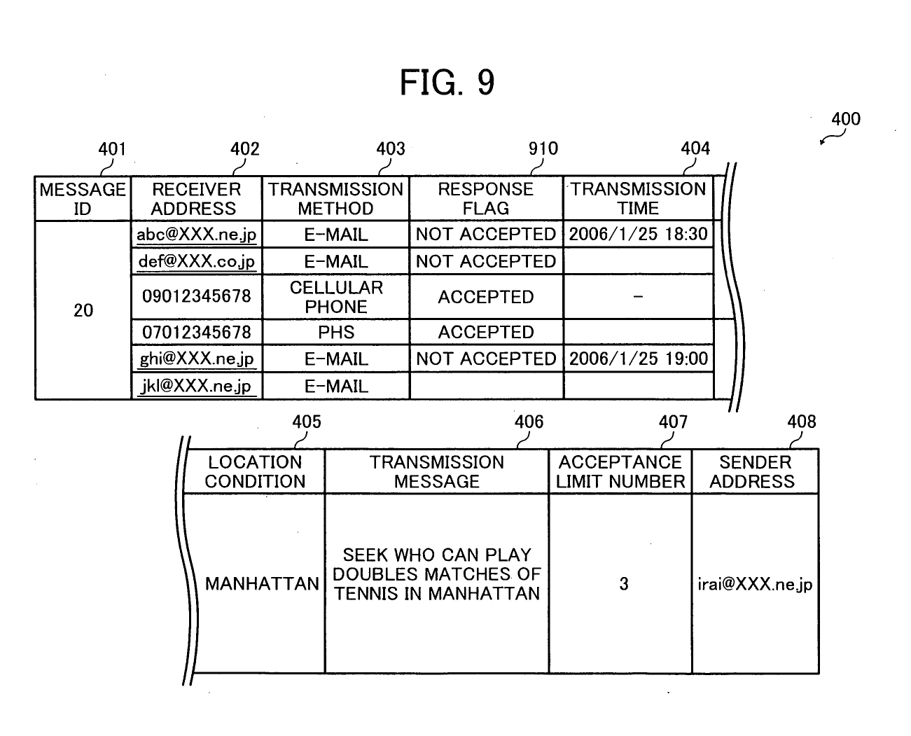

Hereinafter, another example embodiment for message transmission between terminal apparatuses is explained with reference to FIGS. 9 to 13.

Another example embodiment shown in FIGS. 9 to 13 may have a similar configuration shown in FIGS. 4 to 8. Furthermore, such another example embodiment shown in FIGS. 9 to 13 may have a similar hardware configuration shown in FIGS. 1, 2 and 3.

FIG. 9 shows another message-related information table 400, which may store message-related information as similar to the message-related information table 41.

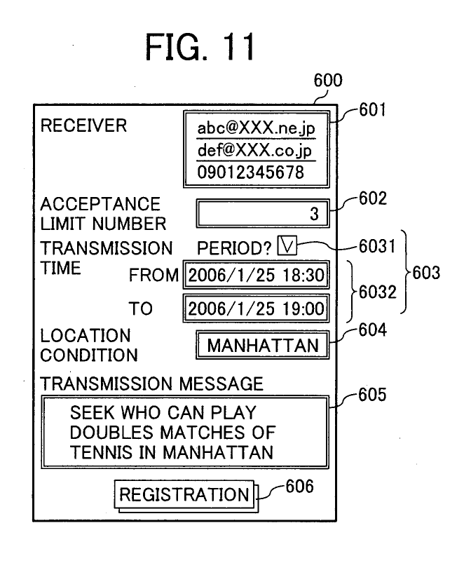

The message-related information shown in FIG. 9 may be input from the sender terminal apparatus 4 with the input screen 600 (refer to FIG. 11).

The message-related information table 400 may have a response flag 910 as shown in FIG. 9, which may be different from the message-related information table 41 of FIG. 4.

The response flag 910 may be set to “ON” for receiver terminal apparatus 5 when the receiver terminal apparatus 5 transmits a response message (e.g., positive or negative message) to the message transmission controller 2.

In other words, if the response flag 910 is set to “ON” for one receiver terminal apparatus 5, such receiver terminal apparatus 5 has transmitted a response message after receiving an action-requesting message.

The response flag 910 may be set to ON if the receiver terminal apparatus 5 sends a response message for the action-requesting message to the message transmission controller 2, and the response flag 910 may be set to OFF if the receiver terminal apparatus 5 does not send a response message for the action-requesting message to the message transmission controller 2.

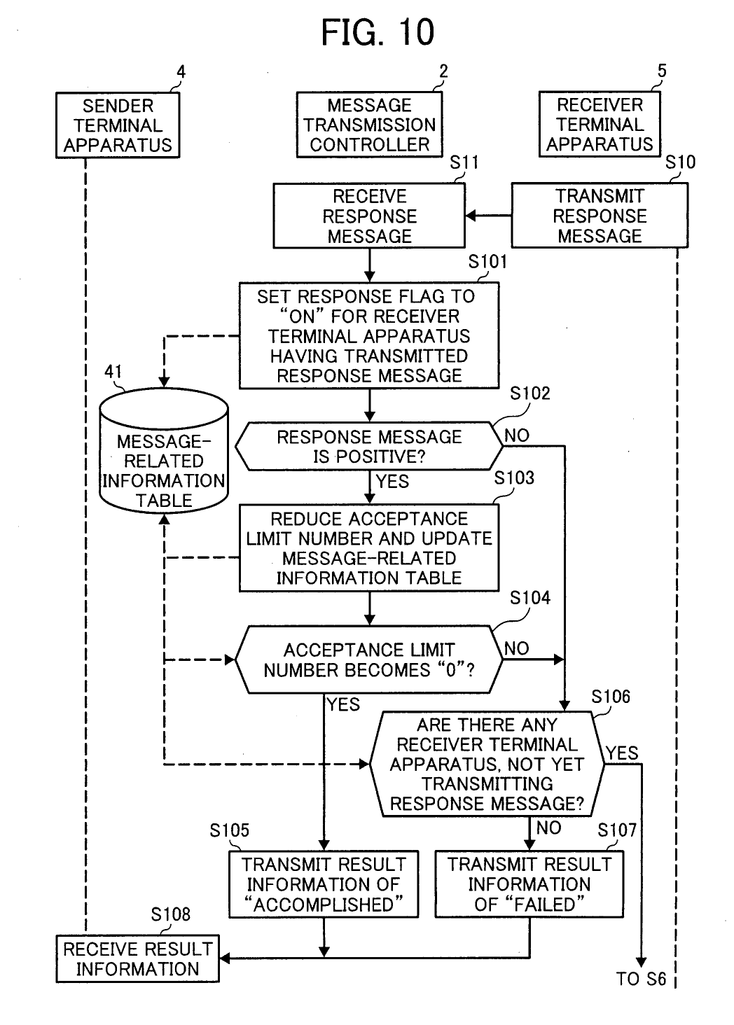

Hereinafter, another controlling process for message transmission by the message transmission system 1 is explained with reference to FIG. 10. A flow chart of FIG. 10 may have similar steps shown in the flow chart of FIG. 5 until step S11.

At step S11 in FIG. 10, the CPU 302 of the message transmission controller 2 may receive a response message from the receiver terminal apparatus 5.

At step S101, the CPU 302 may set a response flag 910 to ON for the receiver terminal apparatus 5, which has transmitted a response message to the message transmission controller 2.

At step S102, the CPU 302 may judge whether the response message received from the receiver terminal apparatus 5 includes a positive response or negative response for the action-requesting message.

In such example embodiment, a “positive response” may be corresponded to the “accept” button 703 and a “negative response” may be corresponded to the “not accept” button 704, which may be pressed by a message receiving person (or responding person) as similar to the previously explained example embodiment.

If the CPU 302 of message transmission controller 2 may judge that the response message includes a positive response for the action-requesting message (Yes at step S102), the CPU 302 may reduce a number of acceptance limit number in the acceptance limit number 407 of the message-related information table 400 for one point, and updates the acceptance limit number in the message-related information table 400 at step S103.

If the CPU 302 may judge that the response message includes a negative response for the action-requesting message (NO at step S102), the process goes to step S106.

At step S104, the CPU 302 may check the updated message-related information table 400 to judge whether the acceptance limit number becomes “0 (zero).”

If the CPU 302 judges that the acceptance limit number becomes “0 (zero)” (Yes at step S104), the CPU 302 may transmit a result information that the message-related information is accomplished in a way that the message sending person has wished to the sender terminal apparatus 4 at step S105.

If the CPU 302 judges that the acceptance limit number does not become “0 (zero)” (No at step S104), the process goes to step S106.

At step S106, the CPU 302 may check a status of the response flag 910 in the message-related information table 400.

If a response flag 910 is set to OFF for a receiver terminal apparatus 5, the CPU 302 may judge that such receiver terminal apparatus 5 has not yet transmitted a response message. If a response flag 910 is set to ON for a receiver terminal apparatus 5, the CPU 302 may judge that such receiver terminal apparatus 5 has transmitted a response message.

If the CPU 302 judges that at least one receiver terminal apparatus 5 has not yet transmitted a response message (Yes at step S106), the process goes back to step S6 of FIG. 5, and a standby condition may be set, in which the message transmission controller 2 may wait for receiving location information from the receiver terminal apparatus 5.

If the CPU 302 judges that all receiver terminal apparatuses 5 have transmitted a response message (No at step S106), the process proceeds to step S107.

A condition at steps S106 and S107 may mean that all receiver terminal apparatuses 5 have already transmitted response messages but the acceptance limit number does not become “0,” which may indicate that an action-requesting message is not accomplished.

If the CPU 302 judges that the acceptance limit number does not become “0 (zero)” (No at step S104) and judges that all receiver terminal apparatuses have already transmitted response messages (No at step S106), the CPU 302 may transmit a result information that the message-related information is not accomplished in a way that the message sending person has wished to the sender terminal apparatus 4 at step S107.

When the sender terminal apparatus 4 may receive the result information from the message transmission controller 2 at step S108, the process has completed.

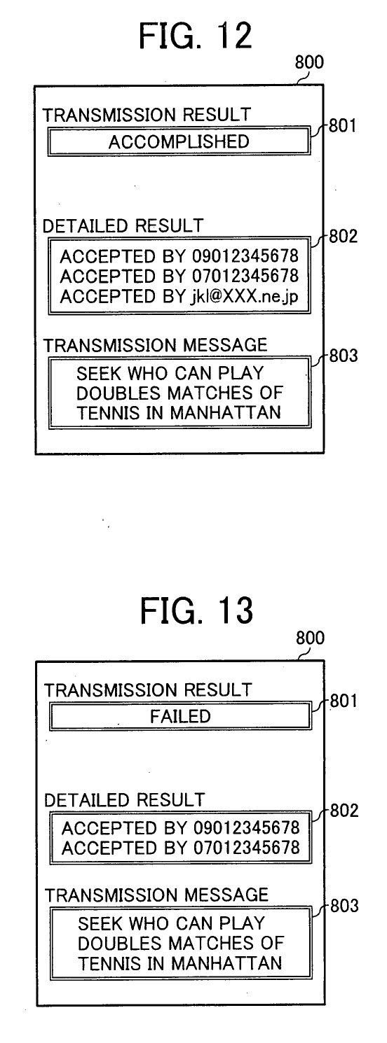

FIGS. 12 and 13 show example result information to be transmitted to the sender terminal apparatus 4 at step S105 and S107, respectively.

As shown in FIG. 9, the message-related information table 400 may include addressee information, such as “jkl@xxx.ne.jp,” having no marks in the response flag 910, which may mean the receiver terminal apparatus having addressee information “jkl@xxx.ne.jp” has not yet transmitted a response message.

Under such condition, assume a first case that the jkl@xxx.ne.jp may transmit a positive response for an action-requesting message of “seek who can play doubles matches of tennis in Manhattan” to the message transmission controller 2, and also assume a second case that the jkl@xxx.ne.jp may transmit a negative response for action-requesting message of “seek who can play doubles matches of tennis in Manhattan” to the message transmission controller 2.

In the first case, the CPU 302 may judge that the acceptance limit number becomes “0” at step S104 because the acceptance limit number is already reduced to from “3” to “1” before the receiver terminal apparatus 5 associated with addressee jkl@xxx.ne.jp transmits a positive response. In the first case, the table 400 shown in FIG. 9 may have three positive responses because the table 400 has already two receiver terminal apparatuses 5 having transmitted positive responses before the receiver terminal apparatus 5 associated with the addressee jkl@xxx.ne.jp transmits a positive response.

Accordingly, the CPU 302 may transmit a result information shown in FIG. 12 that the action-requesting message is “accomplished” to the sender terminal apparatus 4 at step S105.

A doubles match of tennis may need at least four players. If the receiver terminal apparatus 5 of jkl@xxx.ne.jp may transmit a positive response, the message sending person may obtain four people for a doubles matches of tennis, by which the action-requesting message is accomplished.

In the second case, the CPU 302 may judge that the acceptance limit number does not become “0” at step S104 because the acceptance limit number may not be reduced from “1” to “0” because the receiver terminal apparatus 5 associated with addressee jkl@xxx.ne.jp may transmit a negative response. In the second case, the table 400 shown in FIG. 9 may resultantly have only two positive responses because the table 400 has only two receiver terminal apparatuses 5.

Accordingly, the CPU 302 may transmit a result information shown in FIG. 13 that the action-requesting message is “failed” to the sender terminal apparatus 4 at step S107.

A doubles match of tennis may need at least four players. If the receiver terminal apparatus 5 of jkl@xxx.ne.jp may transmit a negative response, the message sending person may obtain only three people for a doubles match of tennis, by which the action-requesting message is not accomplished.

As such, the CPU 302 of message transmission controller 2 can judge whether an action-requesting message is accomplished or not.

Furthermore, the CPU 302 of message transmission controller 2 can check a validity of an action-requesting message during a controlling process as below.

In the above-explanation, if a plurality of receiver terminal apparatuses 5 is used, all receiver terminal apparatuses 5 may need to transmit response messages to the message transmission controller 2 to forward the control process from step S106 to step S107.

However, the message transmission controller 2 can forward the control process from step S106 to step S107 even if one or more receiver terminal apparatuses 5 may not have yet transmitted a response message to the message transmission controller 2 as below.

In such modified control process, the CPU 302 of message transmission controller 2 may check a number of receiver terminal apparatus 5, which has not yet transmitted a response message (i.e., response flag is OFF), and acceptance limit number in the message-related information table 400 to judge validity of action-requesting message.

The validity of action-requesting message may mean a possibility of accomplishment of an action-requesting message requested by a message sending person.

Assume that a number of receiver terminal apparatus 5, which has not yet transmitted a response message (i.e., response flag is set to OFF) may be “X”, and message-related information table 400 may have an acceptance limit number of “Y.” in which “X” and “Y” may mean a present number to be checked.

If a relationship of “X<Y,” the number of receiver terminal apparatus 5 that have not yet transmitted a response message, is smaller than the acceptance limit number of “Y.” Such a condition may be found during a message transmission controlling process.

In such condition, the acceptance limit number may not be reduced to from “Y” to “0” even if all receiver terminal apparatuses 5 may transmit positive responses for the action-requesting message.

Accordingly, the CPU 306 may judge that an action-requesting message may not be accomplished in a manner that a message sending person has wished before transmitting an action-requesting message to all receiver terminal apparatuses 5.

Accordingly, the CPU 306 may judge that message-related information becomes “invalid” before transmitting an action-requesting message to all receiver terminal apparatuses 5.

On one hand, if the CPU 306 may judge that message-related information is still valid before transmitting an action-requesting message to all receiver terminal apparatuses 5, an action-requesting message requested by a message sending person may have a probability of accomplishment.

As above-explained, the message-related information table 400 may include the response flag 910, which indicates whether the receiver terminal apparatus 5 has already transmitted a response message.

With such response flag 910, the CPU 302 can identify which receiver terminal apparatus 5 has already transmitted a response message and which receiver terminal apparatus 5 has not yet transmitted a response message.

With such response flag 910, the CPU 302 may not transmit a same action-requesting message to one receiver terminal apparatus 5, which has already transmitted response message.

Furthermore, the CPU 302 may judge a validity of message-related information during a message transmission process based on a content of response message of receiver terminal apparatus 5 and acceptance limit number as explained above.

Accordingly, if the CPU 302 may judge that an action-requesting message may lose its validity during a message transmission process, the CPU 302 may notify such condition to a message sending person during a message transmission process without transmitting, an action-requesting message to the last receiver terminal apparatus 5.

With such control process, the CPU 302 may prevent a transmission of already invalid action-requesting message to the receiver terminal apparatus 5, which has not yet transmitted a response message.

In example embodiments explained above, when the CPU 302 of message transmission controller 2 may judge that a response message from the receiver terminal apparatus 5 includes a positive response for the action-requesting message, the CPU 302 may reduce an acceptance limit number in the acceptance limit number 407 of the message-related information table 41 (or 400) for one point.

In addition to such method, another method may be employed as below.

For example, when the CPU 302 of message transmission controller 2 may judge that a response message from the receiver terminal apparatus 5 includes a positive response for the action-requesting message, the CPU 302 may increase an acceptance limit number in the acceptance limit number 407 of the message-related information table 41 (or 400) for one point (e.g., incrementing one by one). In such method, the CPU 302 may judge that an action-requesting message requested by a message sending person is accomplished when the acceptance limit number becomes a given number, set in advance.

In example embodiments explained above, one person may use the sender terminal apparatus 4 and another person may use the receiver terminal apparatus 5. However, one person having the sender terminal apparatus 4 can also use the sender terminal apparatus 4 as receiver terminal apparatus 5.

For example, if the receiver box 601 (FIG. 6A) is input with information identifying the sender terminal apparatus 4, one person having the sender terminal apparatus 4 can transmit an action-requesting message to the same sender terminal apparatus 4 as similar to the receiver terminal apparatus 5.

In example embodiments explained above, the transmission limiting information may be set as acceptance limit number. However, the transmission limiting information may be set as “non-acceptance limit number.”

In such a case, the CPU 302 of message transmission controller 2 may count a number of negative responses received from the receiver terminal apparatuses 5 to judge an accomplishment or failure of action-requesting message.

As such, the message transmission controller 2 can limit a number of transmitting times of an action-requesting message to the receiver terminal apparatus 5 based on a content of response message (e.g., positive or negative) received from the receiver terminal apparatus 5.

The present disclosure may be conveniently implemented using a conventional general purpose digital computer programmed according to the teaching of the present disclosure, as will be apparent to those skilled in the art. Appropriate software coding can readily be prepared by skilled programmers based on the teaching of the present disclosure, as will be apparent to those skilled in the art. The present disclosure may also be implemented by the preparation of the application specific integrated circuits or by interconnecting an appropriate network of conventional component circuits, as will be apparent to those skilled in the art.

Numerous additional modifications and variations are possible in light of the above teachings. It is therefore to be understood that within the scope of the appended claims, the disclosure of the present invention may be practiced otherwise than as specifically described herein.

What is claimed is:

1. A message transmission controller for controlling message transmission between a first terminal apparatus and a second terminal apparatus, comprising:
a storing device configured to store a message-related information, the message-related information including addressee information for identifying the second terminal apparatus, location designating information for designating a given location for the second terminal apparatus, and an action-requesting message to be transmitted to the second terminal apparatus, the action-requesting message including a message to be transmitted to the second terminal apparatus from the first terminal apparatus;
a receiving unit configured to receive location information indicating a location of the second terminal apparatus from the second terminal apparatus having the addressee information, stored in the storing device; and
a controlling unit configured to control a message transmission between the first and second terminal apparatus, wherein
the controlling unit determines whether to transmit the action-requesting message, stored in the storing device, to the second terminal apparatus by comparing the location designating information, stored in the storing device, and the location information received from the second terminal apparatus, and
the controlling unit transmits the action-requesting message, stored in the storing device, to the second terminal apparatus when the controlling unit determines to transmit the action-requesting message to the second terminal apparatus, which has transmitted the location information to the receiving unit.

2. The message transmission controller according to claim 1, wherein the message-related information further includes designated-time information including a given time, wherein
the controlling unit further determines whether to transmit the action-requesting message to the second terminal apparatus by comparing a clock time information, indicating a time of receiving the location information of the second terminal apparatus, and the designated-time information, and
the controlling unit transmits the action-requesting message to the second terminal apparatus based on the location information and the clock time information of the second terminal apparatus.

3. The message transmission controller according to claim 2, wherein the clock time information indicates a time when the second terminal apparatus receives the location information or when the message transmission controller receives the location information of the second terminal apparatus.

4. The message transmission controller according to claim 1, wherein the message-related information further includes transmission limiting information to limit the number of times the action-requesting message to the second terminal apparatus is transmitted, wherein
the controlling unit further receives response information for the action-requesting message from the second terminal apparatus,
the controlling unit examines the response information received from the second terminal apparatus to determine whether to update the transmission limiting information; and
the controlling unit updates the transmission limiting information based on the response information.

5. The message transmission controller according to claim 4, wherein the message-related information further includes a response flag, which indicates that the response information was received from the second terminal apparatus, wherein
the controlling unit determines validity of the action-requesting message based on the response flag and the updated transmission limiting information.

6. The message transmission controller according to claim 5, wherein the controlling unit transmits result information of the action-requesting message to the first terminal apparatus based on the validity of the action-requesting message.

7. A method of controlling a message transmission between a first terminal apparatus and a second terminal apparatus, comprising the steps of:
storing message-related information including addressee information for identifying the second terminal apparatus, location designating information for designating a given location for the second terminal apparatus, and an action-requesting message to be transmitted to the second terminal apparatus, the action-requesting message including a message to be transmitted to the second terminal apparatus from the first terminal apparatus;
receiving location information indicating a location of the second terminal apparatus from the second terminal apparatus having the addressee information;
determining whether to transmit the action-requesting message to the second terminal apparatus by comparing the location designating information and the location information received from the second terminal apparatus; and
transmitting the action-requesting message to the second terminal apparatus, which has transmitted the location information, based on the location designating information and the location information.

8. The method according to claim 7, wherein the message-related information further includes designated-time information including a given time, the method further comprising the steps of:
determining whether to transmit the action-requesting message to the second terminal apparatus by comparing a clock time information, indicating a time of receiving the location information of the second terminal apparatus, and the designated-time information; and
transmitting the action-requesting message to the second terminal apparatus based on the location information and the clock time information of the second terminal apparatus.

9. The method according to claim 8, wherein the clock time information indicates a time when the second terminal apparatus receives the location information or when the location information of the second terminal apparatus is received by a controller for controlling the message transmission.

10. The method according to claim 8, wherein the message-related information further includes transmission limiting information to limit the number of times the action-requesting message is transmitted to the second terminal apparatus, the method further comprising the steps of:
receiving response information for the action-requesting message from the second terminal apparatus;
examining the response information received from the second terminal apparatus to determine whether to update the transmission limiting information; and
updating the transmission limiting information based on the response information.

11. The method according to claim 10, wherein the message-related information further includes a response flag, which indicates that the response information was received from the second terminal apparatus, the method further comprising the step of:
determining validity of the action-requesting message based on the response flag and the updated transmission limiting information.

12. The method according to claim 11, further comprising the step of:
transmitting result information of the action-requesting message to the first terminal apparatus based on the validity of the action-requesting message.

13. A computer readable medium storing a program product for controlling a message transmission between a first terminal apparatus and a second terminal apparatus, comprising the steps of:
storing message-related information including addressee information for identifying the second terminal apparatus, location designating information for designating a given location for the second terminal apparatus, and an action-requesting message to be transmitted to the second terminal apparatus, the action-requesting message including a message to be transmitted to the second terminal apparatus from the first terminal apparatus;
receiving location information indicating a location of the second terminal apparatus from the second terminal apparatus having the addressee information;
determining whether to transmit the action-requesting message to the second terminal apparatus by comparing the location designating information and the location information received from the second terminal apparatus; and
transmitting the action-requesting message to the second terminal apparatus, which has transmitted the location information, based on the location designating information and the location information.

14. The computer readable medium according to claim 13, wherein the message-related information further includes designated-time information including a given time, said program product further comprising the steps of:
determining whether to transmit the action-requesting message to the second terminal apparatus by comparing clock time information, indicating a time of receiving the location information of the second terminal apparatus, and the designated-time information; and
transmitting the action-requesting message to the second terminal apparatus based on the location information and the clock time information of the second terminal apparatus.

15. The computer readable medium according to claim 14, wherein the message-related information further includes transmission limiting information to limit the number of times the action-requesting message is transmitted to the second terminal apparatus, said program product further comprising the steps of:
receiving response information for the action-requesting message from the second terminal apparatus;
examining the response information received from the second terminal apparatus to determine whether to update the transmission limiting information; and
updating the transmission limiting information based on the response information.

16. The computer readable medium according to claim 15, wherein the message-related information further includes a response flag, which indicates that the response information was received from the second terminal apparatus, said program product further comprising the step of:
determining the validity of the action-requesting message based on the response flag and the updated transmission limiting information.

17. The computer readable medium according to claim 16, wherein said program product further comprising the step of:
transmitting result information of the action-requesting message to the first terminal apparatus based on the validity of the action-requesting message.
